(19) United States
(12) Patent Application Publication
(10) Pub. No.: US 2022/0379864 A1
(43) Pub. Date: Dec. 1, 2022

(54) ELECTRO MECHANICAL BRAKE AND CONTROL METHOD THEREOF

(71) Applicant: HYUNDAI MOBIS Co., Ltd., Seoul (KR)

(72) Inventors: Yong Cheol SEOL, Hwaseong-si (KR); Jee Sang LEE, Seongnam-si (KR); Tae Chun JEONG, Seongnam-si (KR); Chang Hoe KOO, Anyang-si (KR)

(73) Assignee: HYUNDAI MOBIS Co., Ltd., Seoul (KR)

(21) Appl. No.: 17/752,241

(22) Filed: May 24, 2022

(30) Foreign Application Priority Data
May 25, 2021 (KR) 10-2021-0067204

(51) Int. Cl. B60T 13/74; B60T 7/12; B60T 13/14; H02P 6/28

(52) U.S. Cl. CPC B60T 13/745; B60T 7/12; B60T 13/142; H02P 6/28; B60T 2270/82; B60T 2220/04

(57) ABSTRACT

According to at least one embodiment, the present disclosure provides an electronic braking system comprising: a main master cylinder including a main body, a main piston that is accommodated to be movable in the main body, a main chamber that is defined in the main body and connected with at least one wheel brake, a motor that generates a rotation force, and a power conversion unit that has one side connected with the motor and another side connected with the main piston, and converts a rotational motion of the motor into a straight motion, the main master cylinder being configured to generate hydraulic pressure by movement of the main piston; a motor position sensor disposed to sense a rotation distance of the motor; and a braking controller configured to perform control to move the main piston to a preset initial position by calculating displacement of the main piston based on the rotation distance of the motor and adjusting an amount of a current that is supplied to the motor.

### CROSS-REFERENCE TO RELATED APPLICATION

This application claims priority to and the benefit of Korean Patent Application No. 10-2021-0067204, filed on May 25, 2021, the disclosure of which is incorporated herein by reference in its entirety.

### TECHNICAL FIELD

The present disclosure relates to an electronic brake system and a control method thereof.

### BACKGROUND

Description of this section only provides the background information of the present disclosure without configuring the related art.

An electronic brake system is a system that applies a braking force on each wheel by converting a force depressing a brake pedal by a driver into an electrical signal and driving an actuator based on the electrical signal through a braking controller.

When a driver depresses a brake pedal while driving, a braking controller supplies hydraulic pressure to each wheel by moving a main piston in a main master cylinder by driving an actuator. When the driver releases the brake pedal, the braking controller moves the main piston to a preset initial position.

There are screws, etc. as devices for converting a rotational motion of a motor of the actuator into a straight motion of the main piston. Gaps are formed at the positions where screws are engaged and backlash is generated by these gaps. Backlash may cause a dead stroke when a motor is rotated. Further, there is a problem in that noise is generated and a braking response speed is decreased due to backlash when a braking controller drives a motor.

### SUMMARY

According to at least one embodiment, the present disclosure provides an electronic braking system comprising: a main master cylinder including a main body, a main piston that is accommodated to be movable in the main body, a main chamber that is defined in the main body and connected with at least one wheel brake, a motor that generates a rotation force, and a power conversion unit that has one side connected with the motor and another side connected with the main piston, and converts a rotational motion of the motor into a straight motion, the main master cylinder being configured to generate hydraulic pressure by movement of the main piston; a motor position sensor disposed to sense a rotation distance of the motor; and a braking controller configured to perform control to move the main piston to a preset initial position by calculating displacement of the main piston based on the rotation distance of the motor and adjusting an amount of a current that is supplied to the motor.

### BRIEF DESCRIPTION OF THE DRAWINGS

FIG. 1 is a hydraulic circuit diagram of an electronic braking system according to an embodiment of the present disclosure.

FIG. 2 is a diagram illustrating an operation process of a main master cylinder of FIG. 1.

FIG. 3 is a graph illustrating the operation process of a main master cylinder according to an embodiment of the present disclosure.

FIG. 4 is a flowchart of a method of controlling an electronic braking system according to an embodiment of the present disclosure.

### DETAILED DESCRIPTION

Accordingly, a main object of the present disclosure is to solve the problems that are generated by backlash when a vehicle is braked.

The objects of the present disclosure are not limited to the objects described above and other objects will be clearly understood by those skilled in the art from the following description.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

In the specification, the terms “left” and “right” are used only to describe the directions in which components are shown in figures, and the present disclosure is not limited to the disposition directions and positions.

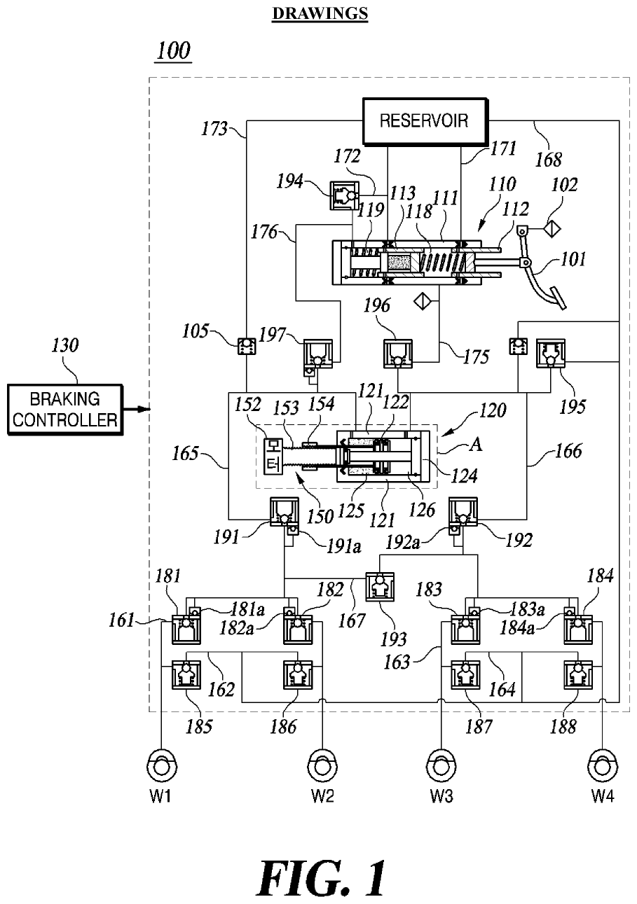

FIG. 1 is a hydraulic circuit diagram of an electronic braking system according to an embodiment of the present disclosure.

Referring to FIG. 1, an automotive braking system 100 includes all or some of a plurality of wheel brakes w1, w2, w3, and w4, a backup master cylinder 110, a main master cylinder 120, and a braking controller 130.

The plurality of wheel brakes w1, w2, w3, and w4 includes a first wheel brake w1 that brakes the rear left wheel of a vehicle, a second wheel brake w2 that brakes the rear right wheel of the vehicle, a third wheel brake w3 that brakes the front left wheel of the vehicle, and a fourth wheel brake w4 that brakes the front right wheel of the vehicle. The first to fourth wheel brakes w1 to w4 are formally defined for the convenience of description and the positions of the first to fourth wheel brakes w1 to w4 are not limited to the positions defined above, respectively.

The backup master cylinder 110 may include all or some of a backup body 111, a first backup piston 112, a second backup piston 113, a reaction force damper 115, a first elastic member 116, and a second elastic member 117.

The backup body 111 is formed in a hollow structure. The first backup piston 112 and the second backup piston 113 are disposed in the internal space of the backup body 111 to be straightly movable to the left and right. A first backup chamber 118 means the internal space of the backup body 111 which corresponds to the portion between the first backup piston 112 and the second backup piston 113. A second backup chamber 119 means the internal space of the backup body 111 which is formed at the left of the second backup piston 113. Although the backup master cylinder 110 having two backup chambers is shown in FIG. 1, the number of the backup chambers is not limited thereto.

The backup body 111 is formed such that the right end is open. The left end of the first backup piston 112 is inserted and disposed in the open right end of the backup body 111. That is, the open right end of the backup body 111 is closed by the first backup piston 112. The right end of the first backup piston 112 is disposed to protrude from the right end of the backup body 111 and a brake pedal 101 is connected to the protruding right end of the first backup piston 112. A stroke sensor 102 that senses the pedal effort of the brake pedal 101 when a driver depresses the brake pedal 101 may be disposed at the brake pedal 101. The first backup piston 112 is disposed to be straightly movable to the left and right in close contact with the inner wall of the backup body 111.

The second backup piston 113 is disposed in the backup body 111 to be straightly movable to the left and right in close contact with the inner wall of the backup body 111. The second backup piston 113 is spaced between the first backup piston 112 and a simulation piston 114a.

The second backup piston 113 may be formed in a hollow structure. The second backup piston 113 may be formed such that the right side facing the first backup piston 112 is closed and the right side is open. The second backup piston 113 is disposed to be straightly movable to the left and right in close contact with the inner wall of the backup body 111.

The first backup piston 112 and the second backup piston 113 can compress the first backup chamber 118 and the second backup chamber 119 when the brake pedal 101 is depressed.

The first elastic member 116 is disposed between the first backup piston 112 and the second backup piston 113. The first elastic member 116 may be a spring. An end of the first elastic member 116 elastically supports the first backup piston 112 and another end of the first elastic member 116 elastically supports the second backup piston 113.

The second elastic member 117 is disposed at the left of the second backup piston 113. The second elastic member 117 may be a spring. An end of the second elastic member 117 elastically supports the second backup piston 113.

The reaction force damper 115 may be disposed in the second backup piston 113. When a driver depresses the brake pedal 101, the reaction force damper 115 is moved to the left of the second backup piston 113, and in this case, the driver feels a reaction force while the reaction force damper 115 is compressed. The reaction force damper 115 may be made of rubber or may be a spring and can make a driver depressing the brake pedal 101 feel a reaction force by elastic resilience of the rubber or spring. The reaction force damper 115 is not limited to this disposition type and may be disposed in the backup master cylinder 110 as long as reaction force damper 115 can make a driver feel a reaction force.

The main master cylinder 120 includes all or some of a main body 121, a main piston 122, an actuator 150, and a main stopper 124. That is, the internal space of the main master cylinder 120 is divided into a first main chamber 125 and a second main chamber 126 by the main piston 122 and the main master cylinder 120 may include the actuator 150 that can supply hydraulic pressure to any one or more of the plurality of wheel brakes w1, w2, w3, and w4 and the simulation chamber in accordance with a driving signal of the braking controller 130.

The main body 121 is formed in a hollow structure. The main piston 122 is disposed to be straightly movable to the left and right in the internal space of the main body 121. The internal space 121 is divided into two spaces by the main piston 122. The first main chamber 125 means the internal space of the main body 121 which corresponds to the left of the main piston 122. The second main chamber 126 means the internal space of the main body 121 which corresponds to the right of the main piston 122.

When the main piston 122 is moved forward to the right, the first main chamber 125 becomes wide and the second main chamber 126 becomes narrow. On the contrary, when the main piston 122 is moved backward to the left, the first main chamber 125 becomes narrow and the second main chamber 126 becomes wide.

The main body 121 is open at the left end and the right end. The right end of the main body 121 is fully open and the left end of the main body 121 is open only at the center portion.

The actuator 150 includes a motor 152 and a power conversion unit. The power conversion unit includes a male screw 153 and a female screw 154. The male screw 153 is disposed such that the right end of the male screw 153 is inserted and disposed in the open left end of the main body 121. The right end of the male screw 153 is connected with the main piston 122 in the main body 121. The male screw 153 may be integrally formed with the main piston 122. The diameter of the male screw 153 is smaller than the diameter of the main piston 122. Spirals are formed on the inner surface of the female screw 154. Spirals that are engaged with the spiral of the female screw 154 are formed on the outer surface of the male screw 153 and the male screw 153 is inserted in the female screw 154.

The left end of the male screw 153 is disposed to protrude from the left end of the main body 121 and the motor 152 that rotates the male screw 153 is disposed at the protruding right end of the male screw 153. A motor position sensor is disposed at the motor 152 to sense a rotation distance of the motor 152. The braking controller 130 measures the rotation distance of the motor 152 using the motor position sensor and converts the rotation distance of the motor 152 into a movement distance of the main piston 122.

The male screw 153 is connected with a rotor shaft of the motor 152. When the rotor shaft of the motor 152 is rotated, the male screw 153 also rotates and straightly moves the female screw 154 engaged with the male screw 153. That is, the male screw 153 and the female screw 154 can straightly move the main piston 122 connected with the male screw 153 to the left and right by converting the rotational motion of the motor 152 into a straight motion.

A gap is generated in the space in which the male screw 153 and the female screw 154 are engaged, and backlash is generated by this gap. Backlash causes operation delay and noise when the actuator 150 is operated.

When a deceleration situation occurs while a vehicle is driven, the male screw 153 is rotated by rotation of the motor 152 and straightly moves the main piston 122 to the right. When the deceleration situation is ended, the braking controller 130 controls the motor 152 to return the main piston 122 to a present initial position by moving the main piston 122 to the left. The braking controller 130 can move the main piston 122 to the present initial position by calculating displacement of the main piston 122 based on the rotation distance of the motor 152 and adjusting the amount of a current that is supplied to the motor 152.

The present initial position means a position spaced a preset distance to the right from a maximum left movement distance of the main piston 122. That is, the preset initial position means a position spaced a predetermined distance from a position at which the main piston 122 cannot be further moved backward in the main body 121.

After the main piston 122 is moved left and stopped at the preset initial position, when the main piston 122 is moved again to the right, backlash may be generated by the gap formed between the spirals of the female screw 152 engaged with the male screw 153. Accordingly, the main piston 122 is not moved at the early stage of backlash even though the motor 152 is rotated, so delay may be generated in braking of a vehicle.

The present disclosure can solve the problem described above through additional control after returning the main piston 122 to the preset initial position when a deceleration situation of a vehicle is ended. The detailed method will be described below.

The male stopper 124 is disposed such that the left end of the main stopper 124 is inserted and disposed in the open right end of the main body 121. That is, the open right end of the main body 121 is closed by the main stopper 124.

The main piston 122 is disposed to be straightly movable to the left and right in close contact with the inner wall of the main body 121. In detail, the center of the outer circumferential surface of the main piston 122 is in close contact with the inner wall of the main body 121, and the left end and the right end of the outer circumferential surface are spaced apart from the inner wall of the main body 121. The main piston 122 is hollow. The male screw 153 is also hollow. The main stopper 124 is disposed to penetrate the main piston 122 and the male screw 153.

The main piston 122 and the male screw 153 are disposed in the first main chamber 125, but the male screw 153 is not disposed in the second main chamber 126. Accordingly, when the main piston 122 is moved to the right, the effective cross-sectional area of the second main chamber 126 becomes larger than the effective cross-sectional area of the first main chamber 125.

The main master cylinder 120 generates hydraulic pressure using rotation of the motor 152 and supplies the generated hydraulic pressure to the plurality of wheel brakes w1, w2, w3, and w4. In detail, when a driver depresses the brake pedal 101, the stroke sensor 102 senses the stroke of the brake pedal 101 and transmits a detection signal to the braking controller 130, and the braking controller 130 calculates the pedal effort of the brake pedal 101 based on the signal received from the stroke sensor 102. The braking controller 130 can control the hydraulic pressure generated by the main master cylinder 120 by controlling the motor 152 based on the calculated pedal effort.

A braking structure that uses the plurality of wheel brakes w1, w2, w3, and w4, the backup master cylinder 110, and the main master cylinder 120 described above is described in detail hereafter.

An end of a first main flow path 165 is connected with the first main chamber 125. In detail, an end of the first main flow path 165 is connected to the main body 121 such that hydraulic pressure can be transmitted to the first main flow path 165 from the first main chamber 125.

A first main control valve 191 that opens/closes the first main flow path 165 is disposed at another end of the first main flow path 165. The first main control valve 191 can regulate the hydraulic pressure that is supplied from the backup master cylinder 110 or the main master cylinder 120.

The first main control valve 191 is a solenoid valve that can open/close the first main flow path 165 in accordance with a control signal of the braking controller 130. For example, the first main control valve 191 may be disposed in a flow path for supplying the hydraulic pressure of the first main chamber 125 to the first and second wheel brakes w1 and w2.

A first main control check valve 191a may be additionally disposed at the first main control valve 191. The first main control check valve 191a is opened when the hydraulic pressure in the first main chamber 125 is a predetermined pressure or higher so that the hydraulic pressure in the first main chamber 125 is detoured to be able to be supplied to the first and second wheel brakes w1 and w2 with the first main control valve 191 closed.

An end of a second main flow path 166 is connected with the second main chamber 126. In detail, an end of the second main flow path 166 is connected to the main body 121 such that hydraulic pressure can be transmitted to the second main flow path 166 from the second main chamber 126.

A second main control valve 192 that opens/closes the second main flow path 166 is disposed at another end of the second main flow path 166. The second main control valve 192 is a solenoid valve that can open/close the second main flow path 166 in accordance with a control signal of the braking controller 130. For example, the second main control valve 192 may be disposed in a flow path for supplying the hydraulic pressure of the second main chamber 126 to the third and fourth wheel brakes w3 and w4.

A second main control check valve 192a may be additionally disposed at the second main control valve 192. The second main control check valve 192a is opened when the hydraulic pressure in the second main chamber 126 is a predetermined pressure or higher so that the hydraulic pressure in the second main chamber 126 is detoured to be able to be supplied to the third and fourth wheel brakes w3 and w4 with the second main control valve 192 closed.

The first main control valve 191 is disposed at an end of a first brake flow path 161. That is, the first main control valve 191 is disposed between the first main flow path 165 and the first brake flow path 161.

A first inlet valve 181 that can adjust hydraulic pressure that is transmitted to the first wheel brake w1 and a second inlet valve 182 that can adjust hydraulic pressure that is transmitted to the second wheel brake w2 are disposed in the first brake flow path 161.

The first inlet valve 181 and the second inlet valve 182 are solenoid valves that can open/close the first brake flow path 161 in accordance with a control signal of the braking controller 130.

A first inlet check valve 181a and a second inlet check valve 182a may be included in the first inlet valve 181 and the second inlet valve 182. The first inlet check valve 181a and the second inlet check valve 182a are check valves for preventing reflux of hydraulic oil in an opposite direction that is not the direction toward the first wheel brake w1 and the second wheel brake w2.

The first wheel brake w1 and the second wheel brake w2 are disposed at another end of the first brake flow path 161. A first outlet valve 185 and a second outlet valve 186 are disposed between the first brake flow path 161 and a first return flow path 162. The first outlet valve 185 and the second outlet valve 186 are solenoid valves that are disposed to recover hydraulic pressure provided to the first wheel brake w1 and the second wheel brake w2 by adjusting opening/closing in accordance with a control signal of the brake controller 130.

For example, if a braking or decelerating situation occurs when a driver depresses the brake pedal 101 or the vehicle is autonomously driving, the braking controller 130 performs control for opening the first inlet valve 181 and the second inlet valve 182, so a braking force can be provided to the first wheel brake w1 and the second wheel brake w2.

On the contrary, if a braking situation is ended after a driver releases the brake pedal 101 or the vehicle is autonomously driving, the braking controller 130 can regulate the hydraulic pressure, which is provided to the first wheel brake w1 and the second wheel brake w2, by performing control for closing the first inlet valve 181 and the second inlet valve 182 and can recover hydraulic pressure by opening the first outlet valve 185 and the second outlet valve 186.

The first return flow path 162 is a flow path for transmitting the recovered hydraulic oil to a reservoir. The reservoir is an oil tank in which hydraulic oil is stored.

Description and coupling relationships of a second brake flow path 163, a second return flow path 164, a third inlet valve 183, a fourth inlet valve 184, a third inlet check valve 183a, a fourth inlet check valve 184a, a third outlet valve 187, a fourth outlet valve 188, the third wheel brake w3, and the fourth wheel brake w4 correspond to and are the same as the above description, so repeated parts are not described.

An end of a third return flow path 168 is connected with the reservoir. Another end of the third return flow path 168 diverges into two parts, so one is connected with the first return flow path 162 and the other one is connected with the second return flow path 164. A second backup valve 195 that opens/closes a flow path is disposed between the third return flow path 168 and the second main flow path 166. The second backup valve 195 is a solenoid valve.

An end of a combination flow path 167 is connected with the first brake flow path 161 and another end of the combination flow path 167 is connected with the second brake flow path 163. A combination valve 193 that can open/close the combination flow path 167 in accordance with a control signal of the braking controller 130 is disposed in the combination channel 167. The combination valve 193 is a solenoid valve. The combination valve 193 is a valve that adjusts hydraulic pressure such that the hydraulic pressure is supplied to the plurality of wheel brakes w1, w2, w3, and w4.

The reservoir is connected to an end of a supply flow path 173 and a supply check valve 105 is connected to another end of the supply flow path 173. The supply check valve 105 prevents reflux of hydraulic oil that is supplied to the first main flow path 165 by the reservoir.

The reservoir is connected to an end of a first backup flow path 171 and a first backup chamber 118 is connected to another end of the first backup flow path 171. That is, the first backup flow path 171 is connected to the backup body 111 through the first backup chamber 118 so that hydraulic oil can pass between the reservoir and the first backup chamber 118.

The reservoir is connected to an end of a second backup flow path 172 and a second backup chamber 119 is connected to another end of the second backup flow path 172. That is, the second backup flow path 172 is connected to the backup body 111 through the second backup chamber 119 so that hydraulic oil can pass between the reservoir and the second backup chamber 119.

The first backup chamber 118 is connected to an end of a third backup flow path 175. That is, the third backup flow path 175 is connected to the backup body 111 through the first backup chamber 118 to be able to pass hydraulic oil that is supplied from the first backup chamber 118. A third backup valve 196 that opens/closes the third backup flow path 175 is disposed at another end of the third backup flow path 175.

The second backup chamber 119 is connected to an end of a fourth backup flow path 176. That is, the fourth backup flow path 176 is connected to the backup body 111 through the second backup chamber 119 to be able to pass hydraulic oil that is supplied from the second backup chamber 119. A fourth backup valve 197 that opens/closes the fourth backup flow path 176 is disposed at another end of the fourth backup flow path 176. The first to fourth backup valves 195, 196, and 197 can regulate hydraulic pressure between the backup master cylinder 110 and the main master cylinder 120.

The first backup valve 194 is disposed between the second backup flow path 172 and the fourth backup flow path 176 and adjusts opening/closing of the flow paths. The first backup valve 194, the second backup valve 195, the third backup valve 196, and the fourth backup valve 197 are solenoid valves that adjust opening/closing in response to a control signal of the braking controller 130. The first backup valve 194 serves to prevent the magnitude of hydraulic pressure generated in the second backup chamber 119 from increasing over a predetermined magnitude.

The first backup valve 194 is also called a pressure reducing valve and is a valve disposed to be able to adjust hydraulic pressure in the second backup chamber 119 by recovering hydraulic oil to the reservoir when hydraulic pressure over a predetermined level is generated in the second backup chamber 119.

The braking controller 130 may be provided to generate a hydraulic pressure supply signal and a valve open and close signal to brake a vehicle when a braking situation of the vehicle occurs. The hydraulic pressure supply signal, which is a signal that the braking controller 130 transmits to the actuator 150, is a signal for generating hydraulic pressure by driving the actuator 150. The valve open and close signal, which is a signal that the braking controller 130 transmits to the valves disposed in the automotive braking system 100, is a signal for adjusting opening/closing of several valves disposed in the automotive braking system 100. The automotive braking system 100 can adjust opening/closing of valves in accordance with the valve open and close signal and can supply a hydraulic braking force corresponding to the hydraulic pressure supply signal to the plurality of wheel brakes w1 to w4.

The braking controller 130 can control the vales included in the automotive braking system 100 and the actuator 150 of the main master cylinder 120. That is, the braking controller 130 can control hydraulic pressure flow in the flow paths in the automotive braking system 100 by transmitting a signal for adjusting opening/closing of the valves included in the automotive braking system 100. Further, the braking controller 130 can diagnose whether the automotive braking system 100 is broken, and can transmit information about the diagnosis result to another braking controller in the vehicle by transmitting a diagnosis result signal through a communication unit (not shown).

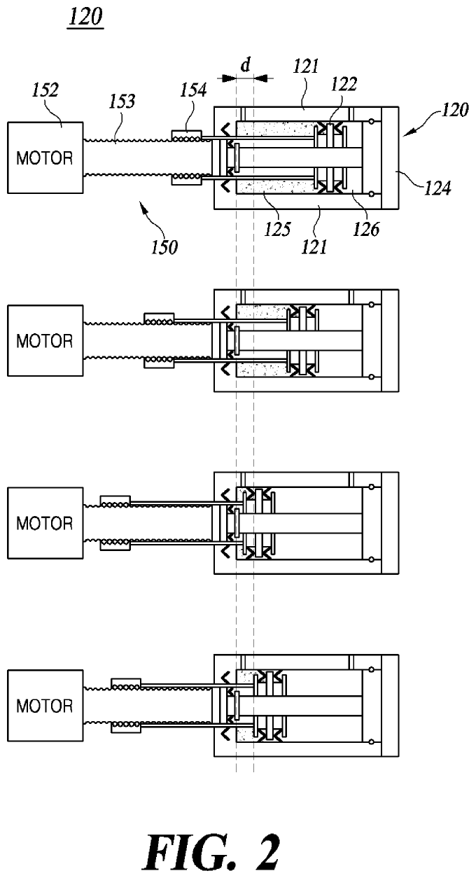

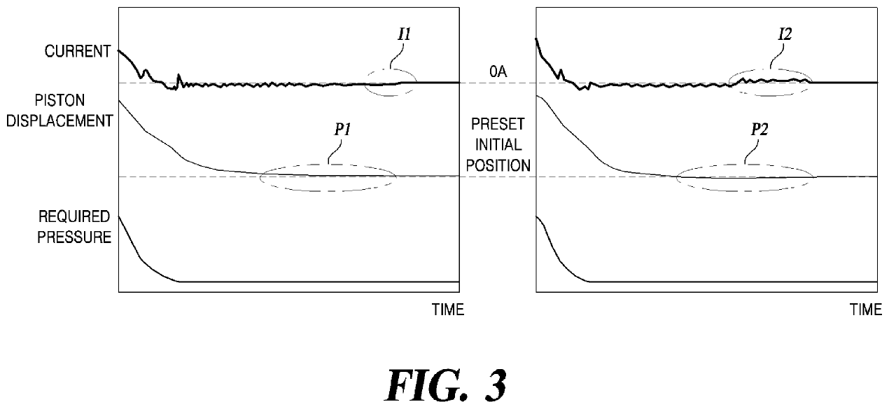

FIG. 2 is a diagram illustrating an operation process of a main master cylinder of FIG. 1. FIG. 3 is a graph illustrating the operation process of a main master cylinder according to an embodiment of the present disclosure.

A first figure of FIG. 2 is a diagram showing the main master cylinder 120 that is driven in a deceleration situation while a vehicle is driven. In a deceleration situation of a vehicle, the braking controller 130 can transmit hydraulic pressure to the plurality of wheel brakes w1, w2, w3, and w4 by moving the main piston 122 to the right by controlling the motor 152.

A second to fourth figures of FIG. 2 show a process of moving the main piston 122 to the preset initial position when a deceleration situation of a vehicle is ended. The preset initial position means a position at which the main piston 122 is spaced by d apart from the left inner wall of the main body 121. In this case, d may be 2 mm.

When a deceleration situation occurs while a vehicle is driven, the braking controller 130 supplies hydraulic pressure to at least one of the wheel brakes (at least one of w1, w2, w3, and w4) by moving the main piston 122 to the right by applying a current to the motor 152. The braking controller 130 can determine whether it is a deceleration situation by receiving a deceleration signal from the outside or receiving a depression signal from the stroke sensor 102 disposed to sense the pedal effort of the brake pedal 101.

When the deceleration situation is ended, as shown in the second figure of FIG. 2, the braking controller 130 performs control to move the main piston 122 toward the preset initial position.

Referring to the third figure of FIG. 2, when the main piston 122 is moved toward the preset initial position, the braking controller 130 moves the main piston 122 backward by a first distance from the preset initial position. In this case, the first distance is smaller than d.

After performing the process of the third figure of FIG. 2, the braking controller 130, as shown in the fourth figure of FIG. 2, performs control such that the main piston 122 reaches again the preset initial position.

When the main piston 122 is stopped for a predetermined time after reaching the preset initial position, the braking controller 130 can set an error value, which is used for position control of the main piston 122, as 0. This is for preventing accumulation of error values.

A first figure of FIG. 3 is a graph when stopping the main piston 122 after directly moving the main piston 122 to the preset initial position using a control method of the related art after a deceleration situation is stopped, and a second figure of FIG. 3 is a graph when stopping the main piston 122 after moving the main piston 122 to the preset initial position through the processes of the first to fourth figures of FIG. 2 when a deceleration situation is ended.

When a deceleration situation of a vehicle is ended, displacement of the main piston 122 is moved toward the preset initial position. In the related art, as shown in the region P1, the main piston 122 does not pass the preset initial position. According to the present disclosure, as shown in the region P2, the main piston 122 reaches again the preset initial position and then stops after passing a predetermined distance through the preset initial position.

When the main piston 122 stops after reaching the preset initial position, the current flowing to the motor 152 of the related art, as shown in the region I1, is a negative current. According to the present disclosure, as in the region I2 of FIG. 3, the current may be a positive current.

As described above, when the main piston 122 reaches again the preset initial position after passing through the preset initial position, there is a technical characteristic that backlash is not generated when a braking situation occurs again and the braking controller 130 rotates the motor 152.

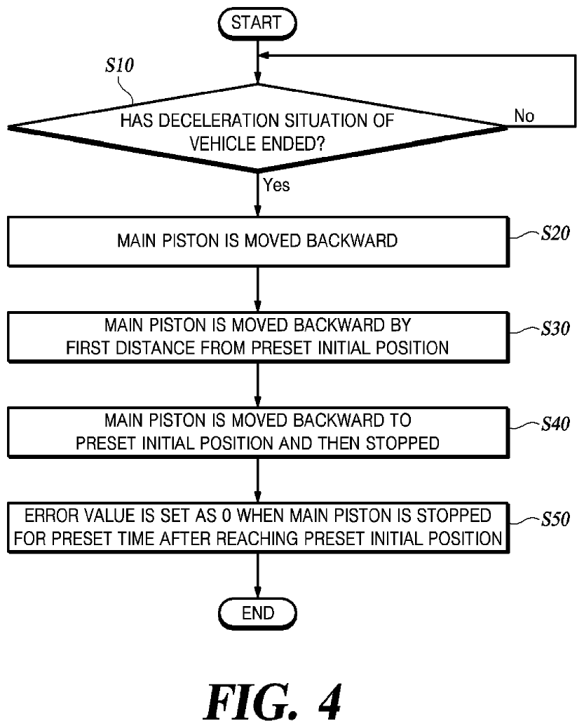

FIG. 4 is a flowchart of a method of controlling an electronic braking system according to an embodiment of the present disclosure. FIG. 4 is a flowchart shown to describe technical characteristics of the present disclosure in a method of controlling an electronic braking system, and shows only a portion of the method of controlling an electronic braking system. A control method including the process shown in FIG. 4 is included in the right range of the present disclosure.

The braking controller 130 performs the algorithm shown in FIG. 4 after a deceleration situation occurs while a vehicle is driven.

The braking controller 130 determines whether the deceleration situation of the vehicle is ended (S10). The braking controller 130 does not perform the following processes until the deceleration situation of the vehicle is ended.

When the braking controller 130 determines that the deceleration situation of the vehicle is ended, the braking controller 130 moves backward the main piston 122 disposed in the main master cylinder 120 using the motor 152 of the main master cylinder 120 (S20). The process S20 corresponds to the second figure of FIG. 2.

After moving the main piston 122 backward, the braking controller 130 performs control to further move backward the main piston by the first distance from the preset initial position (S30). The process S30 corresponds to the third figure of FIG. 2.

The braking controller 130 stops the main piston 122 after moving the main piston to the preset initial position (S40). When the main piston 122 is stopped, a positive current flows to the motor 152. The process S40 corresponds to the fourth figure of FIG. 2.

When the main piston 122 is stopped for a predetermined time after reaching the preset initial position, the braking controller 130 sets an error value, which is generated when measuring displacement of the main piston 122, as 0 (S50).

As described above, according to the present embodiment, the electronic braking system has an effect that it is possible to improve a braking response speed by reducing dead strokes when an actuator is operated.

Further, there is an effect that it is possible to reduce the magnitude of noise when the actuator is operated by preventing backlash.

Although exemplary embodiments of the present disclosure have been described for illustrative purposes, those skilled in the art will appreciate that various modifications, additions, and substitutions are possible, without departing from the idea and scope of the present disclosure. Therefore, exemplary embodiments of the present disclosure have been described for the sake of brevity and clarity. The scope of the technical idea of the present embodiments is not limited by the illustrations. Accordingly, one of ordinary skill would understand the scope of the present disclosure is not to be limited by the above explicitly described embodiments but by the claims and equivalents thereof.

REFERENCE NUMERCIALS

| | |
|---|---|
| 110: backup master cylinder | 120: main master cylinder |
| 130: braking controller | 150: actuator |

What is claimed is:

1. An electronic braking system comprising:
a main master cylinder including a main body, a main piston that is accommodated to be movable in the main body, a main chamber that is defined in the main body and connected with at least one wheel brake, a motor that generates a rotation force, and a power conversion unit that has one side connected with the motor and another side connected with the main piston, and converts a rotational motion of the motor into a straight motion, the main master cylinder being configured to generate hydraulic pressure by movement of the main piston;
a motor position sensor disposed to sense a rotation distance of the motor; and
a braking controller configured to perform control to move the main piston to a preset initial position by calculating displacement of the main piston based on the rotation distance of the motor and adjusting an amount of a current that is supplied to the motor.

2. The electronic braking system of claim 1, wherein the braking controller
supplies hydraulic pressure to the at least one wheel brake by moving the main piston forward by applying a current to the motor when a deceleration situation occurs while a vehicle is driven, and
perform control to move the main piston toward the preset initial position when the deceleration situation is ended.

3. The electronic braking system of claim 2, wherein when the main piston is moved toward the preset initial position, the braking controller performs control such that the main piston is moved backward by a first distance from the preset initial position and then reaches again the preset initial position.

4. The electronic braking system of claim 3, wherein when the main piston is stopped after reaching the preset initial position, the motor is in a state in which a positive current flows.

5. The electronic braking system of claim 3, wherein when the main position is stopped for a preset time after reaching the preset initial position, the braking controller sets an error value, which is used for position control of the main piston, as 0.

6. The electronic braking system of claim 2, wherein the braking controller determines whether the deceleration situation occurs by receiving a deceleration signal from an outside or a depression signal from a stroke sensor disposed to sense a pedal effort of a brake pedal.

7. The electronic braking system of claim 1, wherein the preset initial position is a position spaced by a predetermined distance from a position at which the main piston cannot be further moved backward in the main body.

8. The electronic braking system of claim 1, wherein the power conversion unit includes a male screw connected with a rotor shaft of the motor and a female screw disposed to straightly move in accordance with rotation of the male screw.

9. A method of controlling an electronic braking system, the method comprising:
a first backward movement process of moving a main piston disposed in a main master cylinder backward using a motor of the main master cylinder after a deceleration situation is ended while a vehicle is driven;
a second backward movement process of further moving the main piston backward by a first distance from a preset initial position; and
a stop process of stopping the main piston after moving the main piston to the preset initial position.

10. The method of claim 9, wherein the motor is in a state in which a positive current flows in the stop process.

11. The method of claim 9, further comprising a process of setting an error value, which is used for position control of the main piston, as 0 when the main position is stopped for a preset time after reaching the preset initial position in the stop process.

12. The method of claim 9, wherein the preset initial position is a position spaced by a predetermined distance from a position at which the main piston cannot be further moved backward.
